(19) United States
(12) Patent Application Publication
(10) Pub. No.: US 2002/0072293 A1
(43) Pub. Date: Jun. 13, 2002

(54) Personal computer system having and operating an external animated doll device

(75) Inventors: Michael Beyo, Tel Aviv (IL); Rafel Beyo, Tel Aviv (IL)

Correspondence Address: LOWE HAUPTMAN GILMAN & BERNER, LLP, 1700 Diagonal Road, Suite 310, Alexandria, VA, 22314, US

(73) Assignee: ONE2LINK.COM INC.

(21) Appl. No.: 09/734,894

(22) Filed: Dec. 13, 2000

(51) Int. Cl. G09B 5/00; A63H 30/00

(52) U.S. Cl. 446/175; 434/308

(57) ABSTRACT

A computer system having an external animated doll device connected to the personal computer in order to “personalize” the computer. The external animated doll device represents the computer as if it were a live creature. The external doll device can respond to external stimuli, and can be activated via the Internet. In the present invention, the term “external animated doll” refers to any image or figure having a physical shape or form.

### FIELD OF THE INVENTION

The present invention relates to a personal computer system having and operating an external animated doll device. More specifically, the present invention relates to a system having an external animated doll device, connected to the personal computer in order to “personalize” the computer by using the external animated doll device to represent the computer as if it were a “live” creature. The external doll device can respond to external stimuli, and can be activated via the Internet. The external doll device is preferably attached to the screen frame, and the personal computer proccesses all information required to animate said external doll device. In the present invention the terms “animated doll” and “external doll” refer to any image or figure having a physical shape or form.

### BACKGROUND OF THE INVENTION

It is well known that repetitious activity often leads to boredom. Unfortunately, for many, using their personal computer is repetitious and boring. Yet, they are obliged to spend much of their time using a personal computer, either at work or at home. In spite of new programs developed every year for personal computers, which provide some novelty temporarily, using a personal computer remains an unemotional, dull, and impersonal activity. An external device (external to the personal computer device) that responds to the computer operations and that can make a personal computer more interesting, friendly, and personal is needed.

### SUMMARY OF THE INVENTION

The present invention relates to a computer system having and operating an external animated doll device. Said system comprises at least one personal computer loaded with at least one animation program, for controlling the external animated doll device, at least one external animated doll device, located in close proximity to said personal computer; said external doll device is characterized by being reliant on the personal computer to animate it; and means for communication between the external animated doll device and the personal computer.

The external animated doll device is either in two or three-dimensional planes and is in any real or imaginative shape, and is preferably located in close proximity to the personal computer screen. In certain embodiments the external animated doll device is made of plastic, cloth, wood or paper, or a combination thereof. The external appearance of the animated doll device provides a more personal, interesting and friendlier personal computing environment for the user.

According to various embodiments of the present invention, the personal computer may have means for connecting to a site on the Internet, wherein said Internet site has at least one program useful for animating the external doll device and/or receiving information from said external animated doll device. This can enhance the presentation of an Internet site to include an audio and visual presentation of the information contained in the site via the external doll device.

The communication means for connecting the external animated doll device to the personal computer may be selected from insulated wires, cables, optic fibers, infrared, or any other acceptable carrier of digital or analog signals.

The external animated doll device may contain sensors selected from sound, odor, temperature, humidity, motion, or light sensors, or a combination thereof. Said sensors are connected to the personal computer via said communication means. The information from said sensors is processed by a program within the computer or within an Internet site or an Internet server, and is used to determine and return to the external animated doll device an appropriate animated action command or any other response. It is to be appreciated that the same information can be processed and used to determine and return a command or response to the computer and any associated peripheral equipment. In one preferred embodiment the computer system has a microprocessor, a chip or an electronic board which give the system voice recognition mechanism, allowing it to recognize simple commands and respond with audio or visual output. It will further contain a noise filtering device to better the speech recognition capabilities.

The personal computer may further have means, according to various embodiments, to automatically connect to an Internet site having at least one program useful for animating the external doll device, in response to sensor input. In one preferred embodiment, the program on said Internet site can utilize the animated external doll device to advertise a product. Alternatively, a plurality of Internet users may be connected at once to said Internet site, and each user can animate the external doll device of another user.

In accordance with various preferred embodiments, the external animated doll device has means for providing audio or visual output. Audio means may include a speaker, and may include a microphone and an electronic sound board, for communication of the external animated doll device with the user. Visual output is accomplished by the external animated doll device through movement of said doll device or part thereof, and/or by a selection of lights and/or screens.

According to a further preferred embodiment, means for animating the external animated doll or any part thereof the external animated doll device contains at least one electromechanical or servomechanical arrangement, which enables the external animated doll device or any part thereof to make any movement.

In accordance with one embodiment of the present invention, the external doll device is further activated by a remote control device.

In accordance with one embodiment of the invention, each external animated doll device has a predetermined unique digital identification address, preprogrammed by the manufacturer, describing an address for use with the personal computer and/or Internet program. This unique digital address is useful for sending commands to a specific external animated doll device and identifying sensor information coming from a specific external animated doll device.

In accordance with another embodiment of the invention, means are provided such that the user assigns the unique digital identification address.

In accordance with one preferred embodiment, an electronic multimedia input/output switch is provided, which is connected between the personal computer for providing coordination of the various input and output signals to achieve an integrated multimedia presentation. Although the intent of the switch is to provide functionality for two or more external animated doll devices, said switch can also serve to provide functionality for a single external animated doll device.

According to one preferred embodiment, means are provided for positioning, clamping, or attaching the external animated doll device to the personal computer screen frame, or to any stationary body in close proximity to said personal computer.

### BRIEF DESCRIPTION OF THE DRAWINGS

The present invention is herein described, by way of example only, with reference to the accompanying drawings, wherein:

FIG. 1 illustrates a side view of a preferred embodiment of the system, wherein the external doll device has human form.

FIG. 2 illustrates a frontal view of an external doll device having the form of a snake.

FIG. 3 illustrates the system connected to the Internet.

### DETAILED DESCRIPTION OF THE INVENTION

The present invention relates to a system for animating an external doll device, comprising a personal computer loaded with at least one animation program, at least one animated external doll device located in close proximity to said computer, and means for communication between the external animated doll device and the computer.

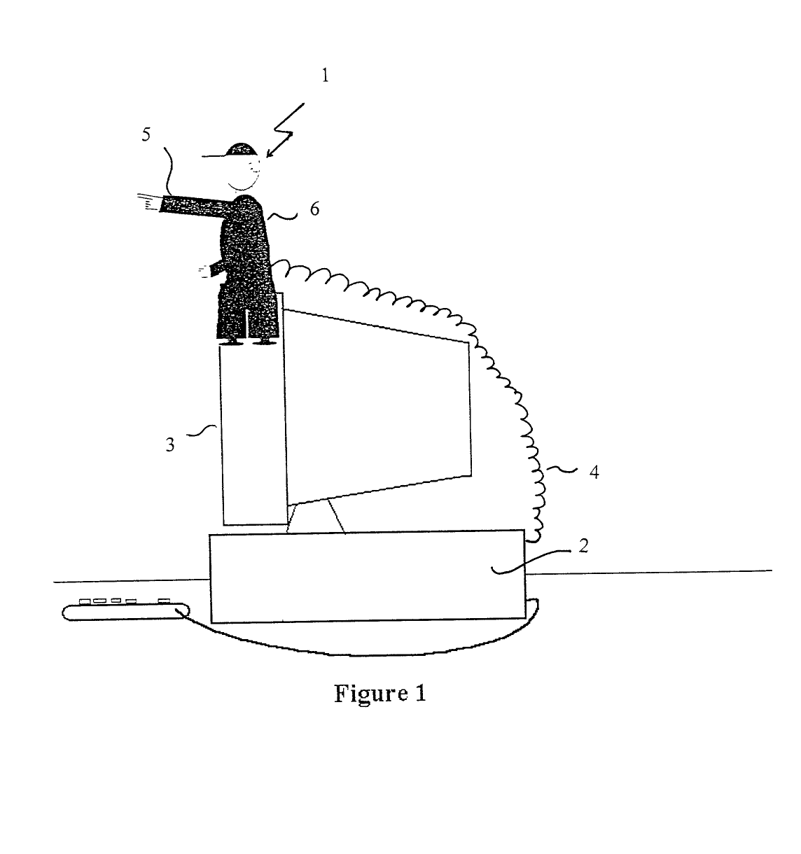

The external animated doll device according to the invention will be further described in detail as relating to FIGS. 1-3. This description by no means intends to limit the scope of the invention, but to clarify and illustrate certain embodiments of the invention.

FIG. 1 illustrates an external animated doll device(1) in the shape of a man, located and connected to the top of the screen frame(3) of a personal computer(2). This preferred location provides the user with the greatest ease of viewing and hearing the multimedia output from the external animated doll device. The external doll device has sensors within(6) that can identify movement or sound within the room. When the user enters the room, or speaks to the doll, the sensors identify his presence or “hear” him. The information from said sensors is sent to the personal computer, which processes it using appropriate software, and the computer outputs an appropriate response to the external doll device. The doll will then gesture(5), speak, or change a facial expression. The doll's response will depend on its shape or form; for example a doll in the shape of a man may move its hands or feet. The software within the computer will analyze the data coming from the sensors within the doll, and determine which response is appropriate to be outputted to the doll. Thus the doll can “answer” the user.

Communication means in the form of a wiring harness(4) connects the external animated doll device to the personal computer. Although the external animated doll device is represented in the shape of a man, it is understood that any two- or three-dimensional form may be considered useful to accomplish the intent of the external animated doll device.

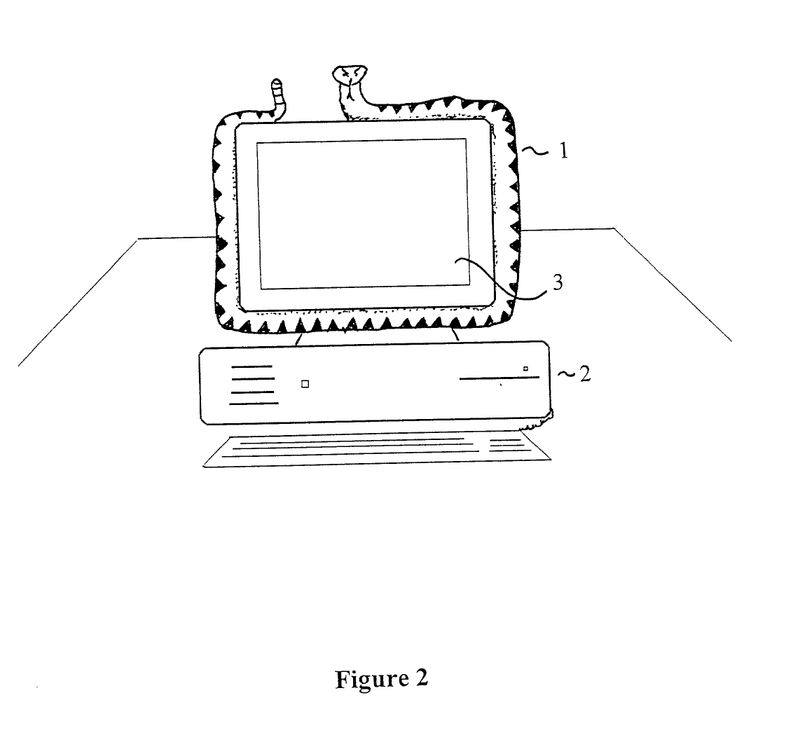

FIG. 2 illustrates an external animated doll device(1) in the shape of a snake coiled around the screen frame(3) of a personal computer(2). The external doll device can have any shape or form to personify the computer, and allow the user to relate to it.

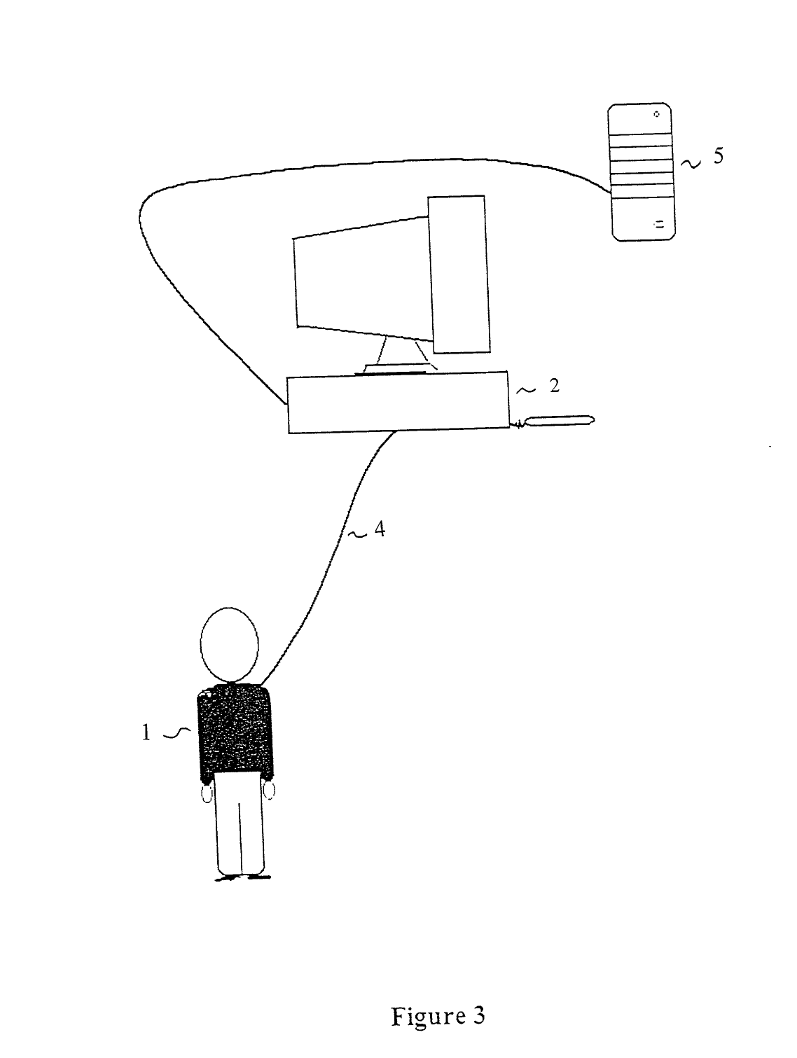

FIG. 3 illustrates an external animated doll device(1) connected with the personal computer(2). The personal computer is also connected to an Internet site(5) containing at least one program to receive input from the external animated doll device and/or the user via the personal computer. The Internet site further has at least one program to control the external animated doll device, and to direct multimedia output to the external animated doll device through the computer. The unique digital identification address within the external animated doll device allows programs located within the personal computer, or located on an Internet site to direct commands to specific dolls, and to identify information received from each one. The internet site contains a program so that several users can interact with each other and animate each others dolls. Advertisers may utilize the Internet site to animate the external doll device in a user's home, so that the external doll device advertises certain products.

1. A computer system having and operating an external animated doll device, comprising: at least one personal computer loaded with at least one animation program; at least one external animated doll device located in close proximity to said personal computer, said external doll device is characterized by being reliant on the personal computer to animate it; and means for communication between said doll device and the personal computer.

2. A system, according to claim 1, wherein the external animated doll device is either in two or three dimensional planes and is in any imaginative shape.

3. A system, according to claim 1, wherein the computer is connected to at least one site on the Internet wherein said Internet site has at least one program useful for animating the external device.

4. A system, according to claim 3, wherein the at least one program on said Internet site can operate the animated external doll device to advertise a product.

5. A system, according to claim 3, wherein if a plurality of Internet users are connected simultaneously to said Internet site, then each user can animate the external doll device of another user.

6. A system, according to claim 1, wherein the means of communication between the external device and the computer is selected from insulated wires, cables, optic fibers or infrared.

7. A system, according to claim 1, wherein the external device has at least one sensor that is selected from sound, odor, temperature, pressure, humidity, motion, or light sensors, wherein said sensor is connected to the personal computer by said communication means, and wherein information from said sensor is processed either by the personal computer or through the Internet, and an appropriate response is outputted to the external animated doll.

8. A system, according to claim 1, wherein the computer system has a voice recognition mechanism, allowing it to recognize simple commands and respond to them with audio or visual output.

9. A system, according to claim 1, wherein the personal computer program has means to automatically connect to an Internet site having at least one program useful for animating the external doll device, in response to a signal received from a sensor located within the external device.

10. A system, according to claim 1, wherein the external animated device has means to provide audio and/or visual output.

11. A system, according to claim 1, wherein the means for providing the external animated device with audio and/or visual output include electromechanical or servomechanical means, speakers, lights, or screens.

12. A system, according to claim 1, wherein the communication means is further comprised of an electronic multimedia input/output switch, connected between at least one external device and the personal computer.

13. A system, according to claim 1, wherein each device has a predetermined unique identification address, or means for determining a unique identification address.

14. A system, according to claim 1, wherein the external animated doll device is made of plastic, cloth, wood, or paper, or a combination thereof.

15. A system, according to claim 1, wherein the external animated doll device is activated by a remote control device.

16. A system, according to claim 1, wherein means are provided for positioning, clamping, or attaching the external animated doll device to the personal computer screen frame, or to any stationary body in close proximity to said personal computer.
